(19) United States
(12) Patent Application Publication
(10) Pub. No.: US 2017/0111304 A1
(43) Pub. Date: Apr. 20, 2017

(54) MOTIVATIONAL TOOLS FOR ELECTRONIC MESSAGES

(71) Applicant: International Business Machines Corporation, Armonk, NY (US)

(72) Inventors: Kevin C. Carr, Raleigh, NC (US); Al Chakra, Apex, NC (US); Jeremy E. Crafts, Raleigh, NC (US); Bryan M. Dempsey, Clinton Corners, NY (US); Marit L. Imsdahl, Morrisville, NC (US); Cheranellore Vasudevan, Bastrop, TX (US)

(21) Appl. No.: 14/884,174

(22) Filed: Oct. 15, 2015

(51) Int. Cl. H04L 12/58; H04L 29/08; G06Q 10/10

(52) U.S. Cl. CPC H04L 51/22; G06Q 10/107; H04L 67/22

(57) ABSTRACT

An email received by a user is determined. A task associated with the email is determined. An incentive content for the email is determined. Responsive to the user completing the task, the incentive content is provided to the user.

### BACKGROUND OF THE INVENTION

The present invention relates generally to the field of electronic mail, and more particularly to motivational tools for responding to electronic mail messages.

Electronic mail, or emails, are digital messages that are exchanged between a sender and one or more recipients. The emails are transferred between devices connected over a network, such as the Internet. Email programs that allow a user to access and manage the emails of the user operate on a client-server model whereby messages are sent to and stored in a networked server for the recipient, thereby allowing for non-real time correspondence between the sender and the recipient. Email programs, which may be web-based or personal computer-based, typically provide a variety of options for managing emails, such as the ability to delete a message, send a message in response back to the sender, and move an email for storage in a particular folder.

### SUMMARY

Embodiments of the present invention include a method, computer program product, and system for providing motivational tools for responding to electronic messages. In one embodiment, an email received by a user is determined. A task associated with the email is determined. An incentive content for the email is determined. Responsive to the user completing the task, the incentive content is provided to the user.

### BRIEF DESCRIPTION OF THE DRAWINGS

FIG. 1 is a functional block diagram of a distributed data processing environment, in accordance with an embodiment of the present invention;

FIG. 2 is a flowchart of operational steps for providing an incentive for responding to incoming emails; and

FIG. 3 is a functional block diagram of components of the computing device of FIG. 1, in accordance with an embodiment of the present invention.

### DETAILED DESCRIPTION

Embodiments of the present invention recognize that society relies heavily on email communication. Embodiments of the present invention recognize that some incoming emails require attention more urgently than other incoming emails. Embodiments of the present invention additionally recognize that responding to emails is a boring task and there is no immediate or tangible incentive for timely addressing an email (e.g., a recipient of an incoming email has no such incentive for replying to the email with the answer to a question contained in the email or for completing a task requested in the email).

Embodiments of the present invention provide for motivating the recipient (user) of an incoming email to timely address the email by providing incentive content (e.g., a game or puzzle) to the user upon determining that the user has addressed the email. The program determines incentive content to use with the incoming emails of the user, determines the urgency of an incoming email, associates incentive content with the incoming email, and provides the user the incentive content upon determining that the user has addressed the incoming email.

Emails are digital messages that are exchanged from a sender to one or more recipients across a network. An individual email may include body text content and subject line text content as well as descriptive information such as the email address of the sender, the email address of the recipient, and the date and time sent. An inbox generally refers to the storage location for the received incoming emails for a user (i.e., the recipient of the emails) and more specifically may refer to the graphical interface through which an email program displays the received incoming emails of the user. An individual email in the inbox of a user may be displayed to the user through a visual representation of the email such as a graphical icon that summarizes various data parameters of the email, including an indication of whether or not the email has been opened by the user.

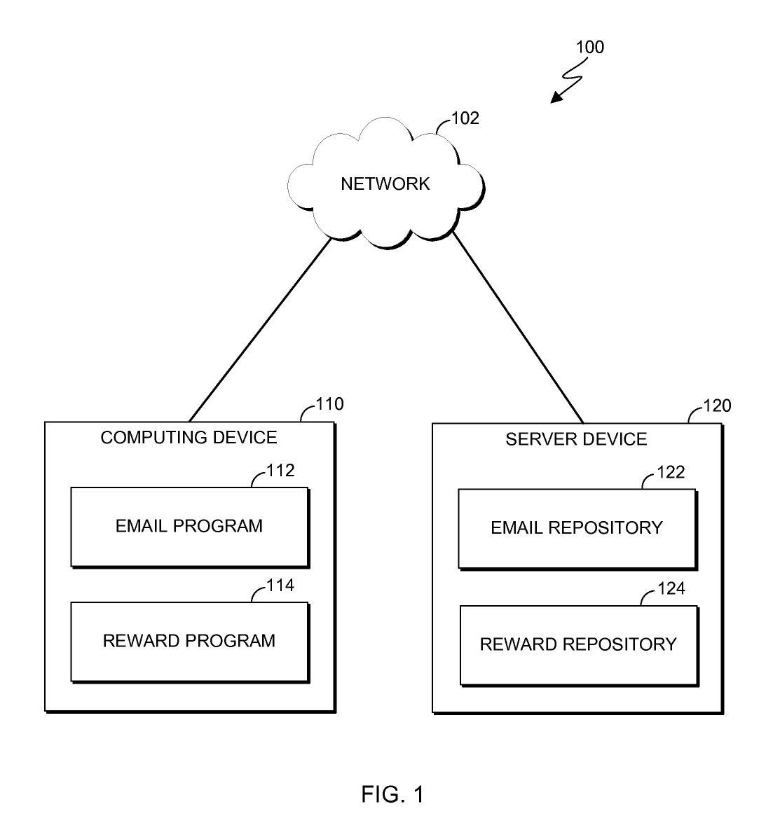

The present invention will now be described in detail with reference to the Figures. FIG. 1 is a functional block diagram illustrating distributed data processing environment 100, in accordance with an embodiment of the present invention. FIG. 1 is for illustrative purposes and does not imply any limitations with regard to the environments in which embodiments of the present invention may be implemented.

In the illustrated embodiment, distributed data processing environment 100 includes computing device 110 and server device 120. Computing device 110 and server device 120 are interconnected through network 102. In an embodiment, network 102 may be a local area network (LAN), a telecommunications network, a wide area network (WAN) such as the Internet, or any combination of the three, and can include wired, wireless, or fiber optic connections. In general, network 102 may be any combination of connections and protocols supports communications between computing device 110, server device 120, and any other computing device connected to network 102, in accordance with embodiments of the present invention.

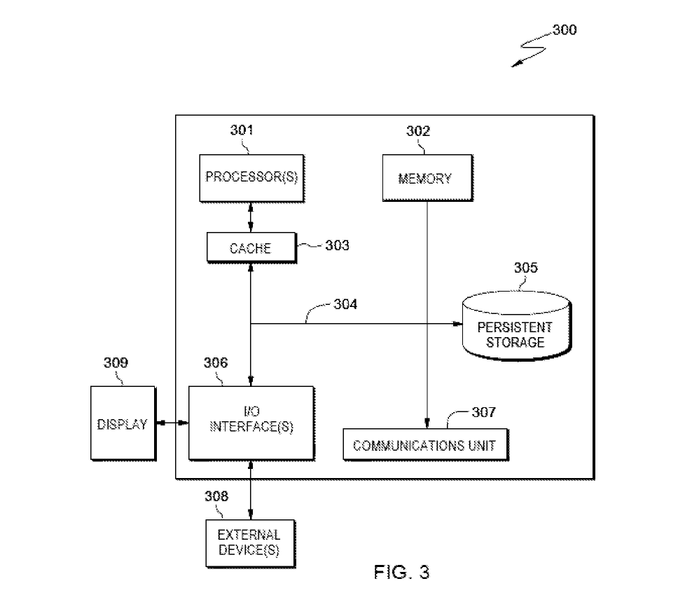

In general, computing device 110 may be any electronic device or combination of electronic devices capable of executing computer readable program instructions. In example embodiments, computing device 110 may be a personal computer, workstation, personal digital assistant, or mobile phone. In an embodiment, computing device 110 may be a computer system utilizing clustered computers and components (e.g., database server devices, application server devices) that act as a single pool of seamless resources when accessed by elements of distributed data processing environment 100, such as in a cloud computing environment. Computing device 110 may include components as depicted and described in further detail with respect to FIG. 3, in accordance with embodiments of the present invention.

In the illustrated embodiment, computing device 110 includes email program 112 and reward program 114. In an alternative embodiment, email program 112 or reward program 114 may be located on another networked computing device (not shown), and a user of computing device 110 may access and utilize email program 112 or reward program 114 through network 102. In an embodiment, email program 112 may be a computer program, application, or subprogram of a larger program that accesses and communicates with email repository 122 for transferring and handling emails, in accordance with embodiments of the present invention. In an embodiment, reward program 114 is a computer program, application, or subprogram of a larger program that accesses and communicates with reward repository 124 and email program 112 for providing rewards in response to a user addressing incoming emails, in accordance with embodiments of the present invention.

In an embodiment, email program 112 may provide functions for transferring emails such as sending, receiving, and retrieving (i.e., from email repository 122). In an embodiment, email program 112 may provide functions for handling and addressing emails such as displaying, responding (e.g., replying, forwarding), composing, editing, and deleting. In the illustrated embodiment, a user of computing device 110 may utilize email program 112 to access email repository 122, located on server device 120, through network 102. For example, in a web application, a user of a personal computer may utilize a web browser (i.e., email program 112) to access, through network 102, the emails associated with the user stored on a remote web server. In an embodiment, email program 112 may be connected to one or more user interface devices (not shown) to allow a user to manipulate emails and otherwise utilize email program 112.

In an embodiment, reward program 114 may provide functions such as determining the urgency of an incoming email, determining a reward (incentive content) for the incoming email, providing the incentive content upon completion of the email task. In the illustrated embodiment, a user of computing device 110 may utilize reward program 114 to access reward repository 124, located on server device 120, through network 102. In an embodiment, reward program 114 may be integrated with email program 112 (e.g., as a plug-in, add-on, extension). In an embodiment, reward program 114 may be connected to one or more user interface devices (not shown) to allow a user to manipulate emails and otherwise utilize reward program 114.

The term “user interface”, as used herein, refers to the information, such as graphic, text, and sound, a program presents to a user and the control sequences the user employs to control the program. There are many types of user interfaces. For example, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in response to the perceived steep learning curve of command-line interfaces, which required commands to be typed on the keyboard. The actions in GUIs are often performed through direct manipulation of the graphical elements.

In general, server device 120 may be any electronic device or combination of electronic devices capable of executing computer readable program instructions. In example embodiments, server device 120 may be a workstation, personal computer, personal digital assistant, or mobile phone. In an embodiment, server device 120 may be a computer system utilizing clustered computers and components (e.g., database server devices, application server devices) that act as a single pool of seamless resources when accessed by elements of distributed data processing environment 100, such as in a cloud computing environment.

In the illustrated embodiment, server device 120 includes email repository 122 and reward repository 124. In an alternative embodiment, email repository 122 may be located on computing device 110, and email program 112 may directly access and communicate with email repository 122. In yet another embodiment, email repository 122 may be located on another networked computer (not shown), and email repository 122 may be accessed by and communicate with email program 112 through network 102. Email repository 122 and reward repository 124 may be implemented using any non-volatile storage media known in the art. For example, email repository 122 and reward repository 124 may be implemented with a tape library, optical library, one or more independent hard disk drives, or multiple hard disk drives in a redundant array of independent disks (RAID). Similarly, email repository 122 and reward repository 124 may be implemented using any suitable storage architecture known in the art. For example, email repository 122 and reward repository 124 may be implemented with a relational database or an object-oriented database.

In an embodiment, email repository 122 contains emails (incoming, outgoing, or otherwise stored) corresponding to one or more users of email program 112, in accordance with embodiments of the present invention. In an embodiment, reward repository 124 contains usage information corresponding to one or more users of reward program 114, in accordance with embodiments of the present invention. In an embodiment, usage information for a user may include historical and current (i.e., updated) incentive content and incentive content preferences (i.e., games, puzzles, videos, images, and other incentive content that is determined, utilized, or updated in accordance with workflow 200 (e.g., step 205)) and urgency information (i.e., information regarding the urgency of incoming emails that is determined, utilized, or updated in accordance with workflow 200 (e.g., step 210)). The incentive content and incentive content preferences may be updated in accordance with step 225 of workflow 200.

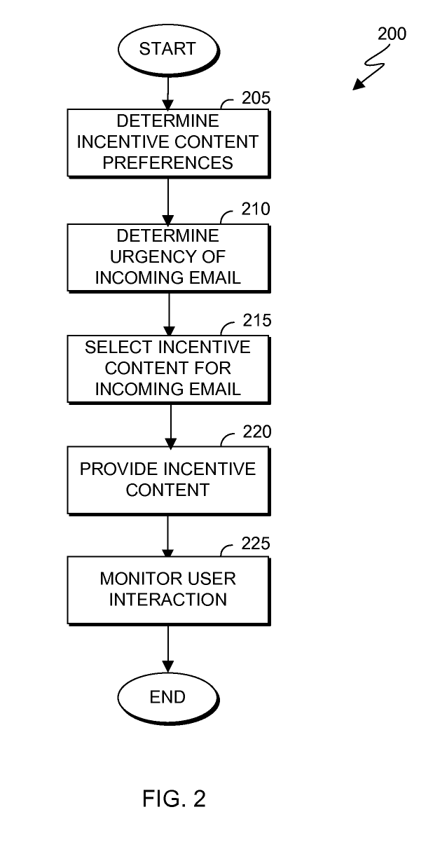

FIG. 2 is a flowchart of workflow 200 illustrating operational steps for providing an incentive for responding to incoming emails. In the illustrated embodiment, the steps of workflow 200 are performed by reward program 114. In an alternative embodiment, the steps of workflow may be performed by any other computer program, or programs, while working with reward program 114. In an embodiment, reward program 114 performs the steps of workflow 200 upon receiving an indication to provide incentive content for the emails of a user of reward program 114. In an embodiment, a user, through the user interface of email program 112 or alternatively reward program 114, may indicate to reward program 114 to provide incentive content for the emails of the user.

Reward program 114 determines incentive content preferences for a user (step 205). In other words, reward program 114 determines incentive content that will motivate a user to address an email. In an embodiment, incentive content includes puzzles (e.g., crossword puzzles, word searches, jigsaw puzzles), games (e.g., solitaire, Sudoku, tic-tac-toe), articles (e.g., news articles, academic articles, sports scores), images (e.g., comic strips, landscapes), and videos (e.g., sports highlights).

In an embodiment, reward program 114 provides the user various incentive content, and the user, through the user interface of email program 112 or alternatively reward program 114, indicates the particular incentive content (e.g., word searches), or general type of incentive content (e.g., puzzles, sports-related content), that the user prefers reward program 114 to use. In an embodiment, the user may additionally rank the indicated incentive content based on the relative ability of each incentive content motivate the user to address an incoming email. For example, the user may indicate to reward program 114 that crossword puzzles are the most motivational incentive content for the user, games are somewhat motivational incentive content, and sports-related incentive content (e.g., sports scores, sports highlights) is least motivational for the user. In an embodiment, the incentive content preferences indicated by the user are associated with the user (e.g., in a user profile) and stored in reward repository 124.

Reward program 114 determines the urgency of an incoming email (step 210). In other words, in an embodiment, reward program 114 analyzes the text content fields of the incoming email for indicators of urgency. For example, reward program 114 may analyze the incoming email for text content (e.g., words, phrases) that is commonly used to request the immediate attention of the recipient such as “immediately,” “tomorrow,” and “urgent.” As another example, reward program 114 may analyze the email incoming email for formatting aspects that are commonly used to indicate urgency such as font aspects (e.g., words with all letters capitalized, bold text, red color text) and punctuation (e.g., “!”). In an embodiment, reward program 114 determines the urgency of the incoming email relative to the urgency of any emails previously received and stored in email repository 122. For example, reward program 114 may determine that the incoming email is more urgent than a previously received email from sender Joe and less urgent than a previously received email from sender Katie.

In an alternative embodiment, the sender of the incoming email, through the user interface of email program 112 or alternatively reward program 114, may indicate the urgency of the incoming email. In yet another alternative embodiment, the user (i.e., recipient), through the user interface of email program 112 or alternatively reward program 114, may indicate the urgency of the incoming email. For example, the user may indicate that an incoming email is urgent by “flagging” the email in the inbox of the user.

Reward program 114 selects incentive content for the incoming email (step 215). In other words, reward program 114 determines the incentive content (indicated by the user (i.e., the recipient of the incoming email) in step 205 and stored in reward repository 124) to associate with the incoming email. In an embodiment, reward program 114 selects the incentive content for the email from among the incentive content indicated in step 205 and stored in reward repository 124. In an embodiment, reward program 114 selects the incentive content that is ranked highest (i.e., the incentive content with the highest motivational rank). In an embodiment, reward program 114 selects the incentive content based on the urgency of the incoming email (determined in step 210). For example, where reward program 114 has determined that the incoming email is not urgent, reward program 114 may determine that incentive content will not be associated with the incoming email, or, alternatively, reward program 114 may select the least motivational incentive content (determined in step 205) to associate with the incoming email. As another example, where reward program 114 has determined that the incoming email is very urgent relative to other previously received incoming emails of the user, reward program 114 may select the most motivational incentive content (determined in step 205) to associate with the incoming email.

In an embodiment, reward program 114 may indicate to the user (i.e., the recipient of the incoming email) that incentive content is associated with the incoming email by providing, through the user interface of reward program 114, a graphical indication, or icon, with the incoming email in the inbox of the user. For example, the graphical icon may be a text character or symbol such as “!”. As another example, the graphical icon may provide an indication of the specific incentive content that is associated with the incoming email such as the text “crossword puzzle” or a preview of the incentive content itself (e.g., an image of the associated crossword puzzle). Reward program 114 may display the graphical icon in a visible location with the incoming email in the inbox of the user, for example near the subject line of the email.

Reward program 114 provides the incentive content (step 220). In other words, reward program 114 provides the user the incentive content associated with the incoming email (from step 215) upon determining that the email has been addressed by the user. In an embodiment, reward program 114 provides the incentive content upon determining that the user has completed a task associated with the email. For example, a task may be sending a reply email in response to an incoming email, in which case reward program 114 may provide the incentive content for the incoming email upon receiving an indication that the user has sent a reply email in response to the incoming email. As another example, a task may be opening an incoming email and moving the incoming email to a new folder in the inbox of the user. As yet another example, a task may be opening and displaying the incoming email for an amount of time (i.e., the task is completed when reward program 114 determines that the user has read the email). The amount of time may be proportional to various data parameters of the email such as the size (i.e., the number of bytes) of the incoming email (e.g., the email must be displayed for at least 1 second per kilobyte of the incoming email) or the number of words contained in the incoming email (e.g., the email must be displayed for at least 1 second per word of the incoming email).

In an embodiment, the graphical icon provided by reward program 114 indicates instructions for completing the task associated with the incoming email. For example, the graphical may include the text “send reply email”. In an embodiment, the sender of the incoming email, through the user interface of email program 112 or alternatively reward program 114, may indicate to reward program 114 the task to be completed by the user for reward program 114 to provide the associated incentive content to the user. The sender may additionally indicate criteria to be used by reward program 114 to determine whether the indicated task has been completed by the user.

In an embodiment, reward program 114 provides incentive content for completing associated tasks at a particular frequency. For example, in an embodiment, reward program 114 may provide incentive content each time the user completes a task associated with an incoming email. In an alternative embodiment, reward program 114 may provide incentive content only after the user has completed a particular number of tasks. For example, upon receiving an indication that the user has completed 10 tasks associated with incoming emails, reward program 114 may provide the user the incentive content for the email of the task which the user completed first. In an embodiment, the frequency at which reward program 114 may provide incentive content is indicated by the user through the user interface of email program 112 or alternatively reward program 114.

In an embodiment, reward program 114 may provide the user the incentive content for a particular length of time. For example, upon determining that the user has completed a task associated with an incoming email, reward program 114 may provide the associated incentive content for 10 minutes. In an embodiment, the length of time is based on the urgency of the incoming email or, similarly, the motivational rank of the associated incentive content. For example, where the incoming email is urgent and the associated incentive content is the most motivational content for the user, reward program 114 may provide the incentive content for a longer period of time as compared to a case where the incoming email is not urgent and the associated incentive content is not the most motivational content for the user. In an embodiment, the length of time for which reward program 114 may provide the user the incentive content is indicated by the user through the user interface of email program 112 or alternatively reward program 114.

Reward program 114 monitors the user interaction (step 225). In other words, reward program 114 monitors any actions the user takes for the incoming email, including the provided incentive content. In an embodiment, reward program 114 monitors the order in which the user completes tasks of emails in the inbox of the user. In an embodiment, reward program 114 monitors the speed at which the user completes tasks for emails of the user, i.e., the amount of time it takes the user to complete tasks for emails of the user. In an embodiment, reward program 114 monitors the amount of time for which the user displays or interacts with the incentive content. Monitored information regarding interactions between the user and incoming emails, including incentive content, may be stored, and updated, in reward repository 124.

In an embodiment, based on the monitored user interaction information, reward program 114 may update urgency determinations for incoming emails for the user (discussed in step 210). For example, where a user repeatedly completes tasks for emails containing the phrase “quarterly financial report” prior to completing tasks for other emails in the inbox of the user, reward program 114 may determine that future incoming emails containing the phrase “quarterly financial report” are very urgent.

In an embodiment, based on the monitored interaction information, reward program may update incentive content preferences for the user (discussed in step 205). For example, where a user repeatedly completes tasks for incoming emails that have associated incentive content of crossword puzzles prior to completing tasks for emails having other associated incentive content, reward program 114 may determine that crossword puzzles are most motivational, or will have a higher rank relative to other incentive content. Reward program 114 may similarly update the preferences for a user where the user repeatedly completes tasks for emails that have associated incentive content of crossword puzzles faster than the user completes tasks for emails having other associated incentive content.

FIG. 3 depicts computing system 300, which illustrates components of computing device 110, which includes email program 112 and reward program 114. Computing system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 may be implemented with one or more buses or a crossbar switch.

Memory 302 and persistent storage 305 are computer readable storage media. In this embodiment, memory 302 includes random access memory (RAM). In general, memory 302 may include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 through I/O interface(s) 306. I/O interface(s) 306 also connect to display 309.

Display 309 provides a mechanism to display data to a user and may be, for example, a computer monitor.

The descriptions of the various embodiments of the present invention have been presented for purposes of illustration, but are not intended to be exhaustive or limited to the embodiments disclosed. Modifications and variations of the presented embodiments will be apparent to those of ordinary skill in the art without departing from the scope and spirit of the invention. The terminology used herein was chosen to best explain the principles of the embodiment, to best explain the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for motivating a recipient to address an email, the method comprising:
determining, by one or more computer processors, an email received by a user;
determining, by one or more computer processors, a task associated with the email;
determining, by one or more computer processors, an incentive content for the email; and
responsive to the user completing the task, providing, by one or more computer processors, the incentive content to the user.

2. The method of claim 1, further comprising:
providing, by one or more computer processors, a graphical indication that the email is associated with an incentive content, wherein the graphical indication includes instructions for completing the task.

3. The method of claim 1, wherein determining an incentive content for the email comprises:
associating, by one or more computer processors, one or more incentive contents with the user based on an indication from the user; and
determining, by one or more computer processors, an incentive content for the email, wherein the incentive content is one of the associated one or more incentive contents.

4. The method of claim 3, further comprising:
ranking, by one or more computer processors, the associated one or more incentive contents, wherein a first incentive content is ranked higher than a second incentive content, wherein the ranking is based on one or more of the following: an indication by the user, an order in which the user completes two or more tasks associated with the email and a second email, and a speed at which the user completes the two or more tasks associated with the email and the second email.

5. The method of claim 4, wherein responsive to the user completing the task, providing the incentive content to the user comprises:
determining, by one or more computer processors, whether the email is urgent; and
responsive to the user completing the task associated with the determined urgent email, providing, by one or more computer processors, a highest ranked incentive content to the user.

6. The method of claim 4, further comprising:
monitoring, by one or more computer processors, at least one action taken by the user for the email; and
updating, by one or more computer processors, one or more of the following based on the monitored at least one action: the associated one or more incentive contents and the ranking of the associated one or more incentive contents.

7. A computer program product for motivating a recipient to address an email, the computer program product comprising:
one or more computer readable storage media; and
program instructions stored on the one or more computer readable storage media, the program instructions comprising:
program instructions to determine an email received by a user;
program instructions to determine a task associated with the email;
program instructions to determine an incentive content for the email; and
program instructions, responsive to the user completing the task, to provide the incentive content to the user.

8. The computer program product of claim 7, further comprising program instructions, stored on the one or more computer readable storage media, to:
provide a graphical indication that the email is associated with an incentive content, wherein the graphical indication includes instructions for completing the task.

9. The computer program product of claim 7, wherein the program instructions to determine an incentive content for the email comprise:
program instructions to associate one or more incentive contents with the user based on an indication from the user; and
program instructions to determine an incentive content for the email, wherein the incentive content is one of the associated one or more incentive contents.

10. The computer program product of claim 9, further comprising program instructions, stored on the one or more computer readable storage media, to:
rank the associated one or more incentive contents, wherein a first incentive content is ranked higher than a second incentive content, wherein the ranking is based on one or more of the following: an indication by the user, an order in which the user completes two or more tasks associated with the email and a second email, and a speed at which the user completes the two or more tasks associated with the email and the second email.

11. The computer program product of claim 10, wherein the program instructions, responsive to the user completing the task, to provide the incentive content to the user comprise:
program instructions to determine whether the email is urgent; and
program instructions, responsive to the user completing the task associated with the determined urgent email, to provide a highest ranked incentive content to the user.

12. The computer program product of claim 9, further comprising program instructions, stored on the one or more computer readable storage media, to:
monitor at least one action taken by the user for the email; and
update one or more of the following based on the monitored at least one action: the associated one or more incentive contents and the ranking of the associated one or more incentive contents.

13. A computer system for motivating a recipient to address an email, the computer system comprising:
one or more computer processors;
one or more computer readable storage media; and
program instructions, stored on the one or more computer readable storage media, for execution by at least one of the one or more computer processors, the program instructions comprising:
program instructions to determine an email received by a user;
program instructions to determine a task associated with the email;
program instructions to determine an incentive content for the email; and
program instructions, responsive to the user completing the task, to provide the incentive content to the user.

14. The computer system of claim 13, further comprising program instructions, stored on the one or more computer readable storage media for execution by the at least one of the one or more computer processors, to:
provide a graphical indication that the email is associated with an incentive content, wherein the graphical indication includes instructions for completing the task.

15. The computer system of claim 13, wherein the program instructions to determine an incentive content for the email comprise:
program instructions to associate one or more incentive contents with the user based on an indication from the user; and
program instructions to determine an incentive content for the email, wherein the incentive content is one of the associated one or more incentive contents.

16. The computer system of claim 15, further comprising program instructions, stored on the one or more computer readable storage media for execution by the at least one of the one or more computer processors, to:
rank the associated one or more incentive contents, wherein a first incentive content is ranked higher than a second incentive content, wherein the ranking is based on one or more of the following: an indication by the user, an order in which the user completes two or more tasks associated with the email and a second email, and a speed at which the user completes the two or more tasks associated with the email and the second email.

17. The computer system of claim 16, wherein the program instructions, responsive to the user completing the task, to provide the incentive content to the user comprise:
program instructions to determine whether the email is urgent; and
program instructions, responsive to the user completing the task associated with the determined urgent email, to provide a highest ranked incentive content to the user.

18. The computer system of claim 15, further comprising program instructions, stored on the one or more computer readable storage media for execution by the at least one of the one or more computer processors, to:
monitor at least one action taken by the user for the email; and
update one or more of the following based on the monitored at least one action: the associated one or more incentive contents and the ranking of the associated one or more incentive contents.
